(19) United States
(12) Patent Application Publication
(10) Pub. No.: US 2026/0081240 A1
(43) Pub. Date: Mar. 19, 2026

(54) BATTERY MANAGEMENT METHOD, BATTERY MANAGEMENT APPARATUS, AND ELECTRONIC DEVICE

(71) Applicant: SHENZHEN MICROBT ELECTRONICS TECHNOLOGY CO., LTD., SHENZHEN, GUANGDONG (CN)

(72) Inventors: Yong LI, SHENZHEN, GUANGDONG (CN); Guo AI, SHENZHEN, GUANGDONG (CN); Zuoxing YANG, SHENZHEN, GUANGDONG (CN)

(73) Assignee: SHENZHEN MICROBT ELECTRONICS TECHNOLOGY CO., LTD., SHENZHEN, GUANGDONG (CN)

(21) Appl. No.: 19/109,398

(22) PCT Filed: Jan. 9, 2024
(86) PCT No.: PCT/CN2024/071243

§ 371 Date: Mar. 6, 2025

(30) Foreign Application Priority Data
Apr. 14, 2023 (CN) 202310440373.X

(51) Int. Cl. H01M 10/42

(52) U.S. Cl. CPC H01M 10/425; H01M 2010/4271

(57) ABSTRACT

The present disclosure relates to a battery management method, a battery management apparatus, and an electronic device. The battery management method includes: acquiring a current power level of a battery for the electronic device when the electronic device receives a wake-up signal; determining an operation mode of the electronic device according to the current power level of the battery, wherein a maximum power in the determined operation mode is supportable by the current power level of the battery; and controlling the electronic device to operate in the determined operation mode.

### CROSS-REFERENCE TO RELATED APPLICATIONS

The present disclosure is a US national stage of International Application No. PCT/CN2024/071243, filed on Jan. 9, 2024, which claims priority to Chinese patent application No. 202310440373.X filed on Apr. 14, 2023. Both of the aforementioned applications are incorporated herein by reference in their respective entireties.

### TECHNICAL FIELD

The present disclosure relates to the field of electronic technology, and in particular, to a battery management method, a battery management apparatus, and an electronic device.

### BACKGROUND

In the electronic device, the endurance of the battery is a problem that has attracted great attention for a long time. In general, to prolong the endurance time of the battery, the electronic device may be set in the dormant state when the electronic device is not used, and the electronic device may be woken up to implement the desired function when the electronic device is used. However, in the current dormancy/wake-up solution, it is difficult to fully use the full power level of the battery, so that the power level of the battery is wasted, and the endurance time of the battery is also shortened. Therefore, there is a need for improving the battery management.

### SUMMARY

An objective of the present disclosure is to provide a battery management method, a battery management apparatus, and an electronic device. An operation state is determined according to the battery power level of an electronic device when the electronic device is woken up, so that the battery power level can be fully used, and the endurance time of the battery can be prolonged.

According to a first aspect of the present disclosure, a battery management method for an electronic device is provided. The battery management method includes:

acquiring a current power level of a battery for the electronic device when the electronic device receives a wake-up signal;

determining an operation mode of the electronic device according to the current power level of the battery, wherein a maximum power in the determined operation mode is supportable by the current power level of the battery; and

controlling the electronic device to operate in the determined operation mode.

In some embodiments, the wake-up signal includes at least one of:

a key triggering signal;

a touch screen triggering signal; or

a timer triggering signal.

In some embodiments, a timer configured to generate the timer triggering signal includes at least one of a software timer or a hardware timer.

In some embodiments, determining the operation mode of the electronic device according to the current power level of the battery includes:

determining a preset operation mode corresponding to the current power level of the battery as the operation mode of the electronic device according to a preset corresponding relationship between the current power level of the battery and the operation mode of the electronic device.

In some embodiments, determining the operation mode of the electronic device according to the current power level of the battery includes at least one of:

when the current power level of the battery is greater than or equal to a first preset power level, determining and displaying a plurality of candidate operation modes that are supportable by the current power level of the battery, receiving a selection instruction from a user, and determining a corresponding one of the plurality of candidate operation modes as the operation mode of the electronic device according to the selection instruction; or

when the current power level of the battery is less than a second preset power level, determining an operation mode corresponding to the current power level of the battery as the operation mode of the electronic device,

wherein the second preset power level is less than or equal to the first preset power level.

In some embodiments, the battery management method further includes:

receiving a customization instruction from a user when the electronic device is in a wake-up state; and

determining a function contained in a corresponding operation mode according to the customization instruction.

In some embodiments, the operation mode of the electronic device includes at least one of:

a first operation mode, wherein in the first operation mode, the electronic device is capable of implementing all functions;

a second operation mode, wherein in the second operation mode, a function with the maximum power greater than or equal to a first maximum power threshold in the electronic device is disabled;

a third operation mode, wherein in the third operation mode, a peripheral device that is powered by the electronic device and has the maximum power greater than or equal to a second maximum power threshold is disabled;

a fourth operation mode, wherein in the fourth operation mode, local triggering wake-up of the electronic device is disabled, and the electronic device is in a network on-line state; or

a fifth operation mode, wherein in the fifth operation mode, the electronic device is in a network off-line state, and the electronic device remains in local charged dormancy,

wherein a first maximum power in the first operation mode is greater than a second maximum power in the second operation mode, the second maximum power in the second operation mode is greater than a third maximum power in the third operation mode, the third maximum power in the third operation mode is greater than a fourth maximum power in the fourth operation mode, and the fourth maximum power in the fourth operation mode is greater than a fifth maximum power in the fifth operation mode.

In some embodiments, determining the operation mode of the electronic device according to the current power level of the battery includes:

when the current power level of the battery is greater than or equal to a first preset proportion of a full power level of the battery, determining the first operation mode as the operation mode of the electronic device;

when the current power level of the battery is less than the first preset proportion of the full power level of the battery, and is greater than or equal to a second preset proportion of the full power level of the battery, determining the second operation mode as the operation mode of the electronic device;

when the current power level of the battery is less than the second preset proportion of the full power level of the battery, and is greater than or equal to a third preset proportion of the full power level of the battery, determining the third operation mode as the operation mode of the electronic device;

when the current power level of the battery is less than the third preset proportion of the full power level of the battery, and is greater than or equal to a fourth preset proportion of the full power level of the battery, determining the fourth operation mode as the operation mode of the electronic device; or

when the current power level of the battery is less than the fourth preset proportion of the full power level of the battery, determining the fifth operation mode as the operation mode of the electronic device,

wherein the first preset proportion is greater than the second preset proportion, the second preset proportion is greater than the third preset proportion, and the third preset proportion is greater than the fourth preset proportion.

In some embodiments, the first preset proportion is 45%˜50% or 50%˜55%, the second preset proportion is 25%˜30% or 30%˜35%, the third preset proportion is 7%˜10% or 10%˜13%, and the fourth preset proportion is 2%˜5% or 5%˜8%.

In some embodiments, controlling the electronic device to operate in the determined operation mode includes:

acquiring a next initial triggering moment and a maximum delayable time of each of one or more timers to be triggered,

calculating a latest triggering moment of each timer according to the initial triggering moment and the maximum delay able time of each timer, and

setting a latest triggering moment that is closest to a current moment of one or more latest triggering moments of the one or more timers as a next wake-up moment of the electronic device.

In some embodiments, controlling the electronic device to operate in the determined operation mode includes:

acquiring a next initial triggering moment and a maximum advanceable time of each of one or more timers to be triggered,

calculating an earliest triggering moment of each timer according to the initial triggering moment and the maximum advanceable time of each timer, and

triggering the timer when the earliest triggering moment of the timer is earlier than or equal to a current triggering moment.

In some embodiments, the next wake-up moment of the electronic device is set in a hardware timer.

In some embodiments, at least one of the delayable time or the advanceable time of the timer is set when the timer is created.

According to a second aspect of the present disclosure, a battery management apparatus for an electronic device is provided. The battery management apparatus includes a memory and a processor, wherein the memory has instructions stored thereon, and when the instructions are executed by the processor, steps of the battery management method as mentioned above are implemented.

According to a third aspect of the present disclosure, an electronic device is provided. The electronic device includes the battery management apparatus as mentioned above.

In some embodiments, the electronic device includes at least one of a video camera or a camera.

According to a fourth aspect of the present disclosure, a computer-readable storage medium is provided. The computer-readable storage medium has instructions stored thereon, and when the instructions are executed by a processor, steps of the battery management method as mentioned above are implemented.

Through the following detailed descriptions of exemplary embodiments of the present disclosure with reference to the accompanying drawings, other features and their advantages of the present disclosure will become clear.

### BRIEF DESCRIPTION OF THE DRAWINGS

The accompanying drawings that constitute a part of the specification illustrate embodiments of the present disclosure, and are used for explaining the principle of the present disclosure together with the specification.

With reference to the accompanying drawings, according to the following detailed description, the present disclosure can be more clearly understood, in which

FIG. 1 shows a schematic flowchart of a battery management method according to an exemplary embodiment of the present disclosure;

FIG. 2 shows a diagram of the corresponding relationship between the current power level of the battery and the operation mode of the electronic device according to a specific example of the present disclosure;

FIG. 3 shows a schematic flowchart of step S200 in the battery management method according to a specific embodiment of the present disclosure;

FIG. 4 shows a schematic flowchart of step S300 in the battery management method according to another specific embodiment of the present disclosure;

FIG. 5 shows a schematic flowchart of step S300 in the battery management method according to still another specific embodiment of the present disclosure;

FIG. 6 shows a schematic diagram of the wake-up time of the electronic device according to a specific example of the present disclosure; and

FIG. 7 shows a block diagram of an electronic device according to an exemplary embodiment of the present disclosure.

It is to be noted that in implementations illustrated in the following, sometimes a same reference sign is used in different accompanying drawings to represent a same part or parts with a same function, and repeated description thereof is omitted. In the specification, similar numbers and letters are used for representing similar items. Therefore, once an item is defined in an accompanying drawing, the item in subsequent accompanying drawings will not be further discussed.

For ease of understanding, locations, sizes, scopes and the like of various structures shown in the accompanying drawings sometimes do not represent the actual locations, sizes, scopes and the like. Therefore, the disclosed invention is not limited to the locations, sizes, scopes and the like disclosed in the accompanying drawings and the like. Moreover, the accompanying drawings are not necessarily drawn to scale, and some features may be exaggerated to show the details of specific components.

### DETAILED DESCRIPTION

Various exemplary embodiments of the present disclosure will be described in detail with reference to the accompanying drawings now. It should be noted that unless illustrated in detail otherwise, the relative deployment of components and steps, numerical expressions and values stated in these embodiments do not limit the scope of the present disclosure.

In fact, the following description of at least one exemplary embodiment is merely illustrative, and in no way puts any limitation on the present disclosure and the application or use thereof. That is, various technologies, methods, and devices herein are shown in an exemplary manner to describe different embodiments in the present disclosure, and are not intended to be restrictive. Those skilled in the art will understand that they only illustrate the exemplary manners that can be used for implementing the present disclosure, rather than exhaustive manners.

Technologies, methods, and devices known to those skilled in the art may not be discussed in detail, but in proper circumstances, the technologies, methods, and devices should be regarded as a part of the specification.

To prolong endurance time of a battery for an electronic device, the operation of the electronic device may be controlled based on a dormancy/wake-up solution. Specifically, when the electronic device is not used, the electronic device may be set in the dormant state, and in this case, the power consumption of the electronic device is relatively low; and when the electronic device needs to be used, the electronic device may be woken up to implement the desired function. However, in the process in which the electronic device implements various functions, the maximum power (or instantaneous peak power) that needs to be consumed may be different. Furthermore, in a case that the battery has different remaining power levels, the maximum power that is supportable by the battery is usually different. Therefore, to enable the electronic device to normally operate various functions after being woken up, generally, when a fair amount of power level remains in the battery, the electronic device needs to be set to no longer be woken up. However, by the setting manner of this solution, as long as the electronic device can be woken up, the remaining power level of the battery for the electronic device is still sufficient to support the operation of various functions of the electronic device, thereby avoiding the crash, restart and the like of the electronic device due to the fact that the battery power level cannot support some functions with relatively high maximum power. For example, when 20% of power level still remains in the battery, the normal operation of some high-power functions may not be supported. In this case, the electronic device is set to be incapable of being woken up or to automatically shut down directly, and the remaining 20% of power level cannot be effectively used. However, in an actual situation, although the remaining 20% of power level cannot support the operation of the high-power function, it may still be able to support some low-power functions. It can be seen that in such a battery management manner, a fair amount of power level in the battery cannot be fully used, resulting in a reduced endurance time of the battery.

To solve the above problem, the present disclosure provides a battery management method for an electronic device. An operation state of the electronic device after the electronic device is woken up is determined according to a battery power level, thereby fully using the battery power level. In an exemplary embodiment of the present disclosure, as shown in FIG. 1, the battery management method may include:

step S100, acquiring a current power level of a battery for an electronic device when the electronic device receives a wake-up signal.

The wake-up signal may include at least one of a key triggering signal, a touch screen triggering signal, or a timer triggering signal. Specifically, a user may perform an operation on a user interaction interface, such as a key, a touch screen or the like, set in the electronic device to wake up the electronic device. In general, once receiving these triggering signals from the user interaction interface, the electronic device may be immediately woken up to respond to the requirement of the user in time. Alternatively, to enable the electronic device in the dormant state to still normally operate a function necessary for keeping alive (for example, periodically monitoring various operating parameters of the electronic device and the like), the electronic device may be periodically woken up by setting one or more timers. When the electronic device is woken up by the timer, the electronic device may perform a corresponding action based on the triggering of the timer. Here, the timer may include a hardware timer in a form of hardware, or may include a software timer written in program software in a form such as program codes and the like, both of them may be configured to generate the timer triggering signal, which is not limited herein.

The battery for supplying power to the electronic device may be arranged inside the electronic device, or may be an external battery arranged independent of the electronic device and electrically connected to the electronic device, which is not limited herein. When the electronic device receives the wake-up signal, a corresponding component such as a single-chip microcomputer and the like in the electronic device may communicate with the battery to acquire the current power level of the battery.

Returning to FIG. 1, the battery management method may further include:

step S200, determining an operation mode of the electronic device according to the current power level of the battery.

The maximum power in the determined operation mode is supportable by the current power level of the battery. That is, the current power level of the battery can support the operation of various functions in the operation mode after the electronic device is woken up, thereby avoiding the crash, restart and the like of the electronic device due to the fact that the battery power level is insufficient to support the maximum power, and further improving the user's experience.

The operation mode of the electronic device may be determined according to the current power level of the battery in multiple manners. In some embodiments, a corresponding relationship between the current power level of the battery and the operation mode may be preset. Once the current power level of the battery is acquired, a preset operation mode corresponding to the current power level of the battery may be directly determined as the operation mode of the electronic device according to the preset corresponding relationship between the current power level of the battery and the operation mode of the electronic device. In the determined operation mode, the electronic device may operate a corresponding function, and the maximum power consumption required for implementing the function is supportable by the current power level of the battery.

In a specific embodiment, operation modes of the electronic device may include a first operation mode (for example, a performance mode), a second operation mode (for example, a standard mode), a third operation mode (for example, a low-power mode), a fourth operation mode (for example, a standby mode), and a fifth operation mode (for example, a power-exhaust mode). In the first operation mode, the electronic device is capable of implementing all functions, including an additional function with high power consumption for improving the performance of the electronic device, and the like. In the second operation mode, a function with the maximum power greater than or equal to a first maximum power threshold in the electronic device may be disabled. For example, a function that highly consumes power, such as an intelligent algorithm and the like, in the electronic device may be disabled. In the third operation mode, a peripheral device that is powered by the electronic device and has the maximum power greater than or equal to a second maximum power threshold may be disabled. For example, in a case that the electronic device is a video camera or a camera, the peripheral device, such as a fill light, a horn or the like, that is powered by the video camera or the camera and highly consumes power may be disabled. In addition, in this specific embodiment, the second maximum power threshold may be less than the first maximum power threshold. In the fourth operation mode, the local triggering wake-up of the electronic device may be disabled, and the electronic device remains in a network on-line state. In the fifth operation mode, the electronic device may be in a network off-line state, and the electronic device remains in local charged dormancy. Here, a first maximum power in the first operation mode may be greater than a second maximum power in the second operation mode, the second maximum power in the second operation mode may be greater than a third maximum power in the third operation mode, the third maximum power in the third operation mode may be greater than a fourth maximum power in the fourth operation mode, and the fourth maximum power in the fourth operation mode may be greater than a fifth maximum power in the fifth operation mode. That is, as the current power level of the battery decreases, functions that can be implemented in the operation state after the electronic device is woken up also decrease correspondingly. As the current power level of the battery decreases, a function that consumes low power or is necessary for maintaining the basic operation of the electronic device in the electronic device is preferentially maintained, while an additional function that consumes high power and is used for implementing high performance in the electronic device is preferentially disabled.

Based on the foregoing five operation modes, determining the operation mode of the electronic device according to the current power level of the battery may include: when the current power level of the battery is greater than or equal to a first preset proportion of a full power level of the battery, determining the first operation mode as the operation mode of the electronic device; when the current power level of the battery is less than the first preset proportion of the full power level of the battery, and is greater than or equal to a second preset proportion of the full power level of the battery, determining the second operation mode as the operation mode of the electronic device; when the current power level of the battery is less than the second preset proportion of the full power level of the battery, and is greater than or equal to a third preset proportion of the full power level of the battery, determining the third operation mode as the operation mode of the electronic device; when the current power level of the battery is less than the third preset proportion of the full power level of the battery, and is greater than or equal to a fourth preset proportion of the full power level of the battery, determining the fourth operation mode as the operation mode of the electronic device; or when the current power level of the battery is less than the fourth preset proportion of the full power level of the battery, determining the fifth operation mode as the operation mode of the electronic device. The first preset proportion is greater than the second preset proportion, the second preset proportion is greater than the third preset proportion, and the third preset proportion is greater than the fourth preset proportion. For example, the first preset proportion may be 45%˜50% or 50%˜55%, the second preset proportion may be 25%˜30% or 30%˜35%, the third preset proportion may be 7%˜10% or 10%˜13%, and the fourth preset proportion may be 2%˜5% or 5%˜8%.

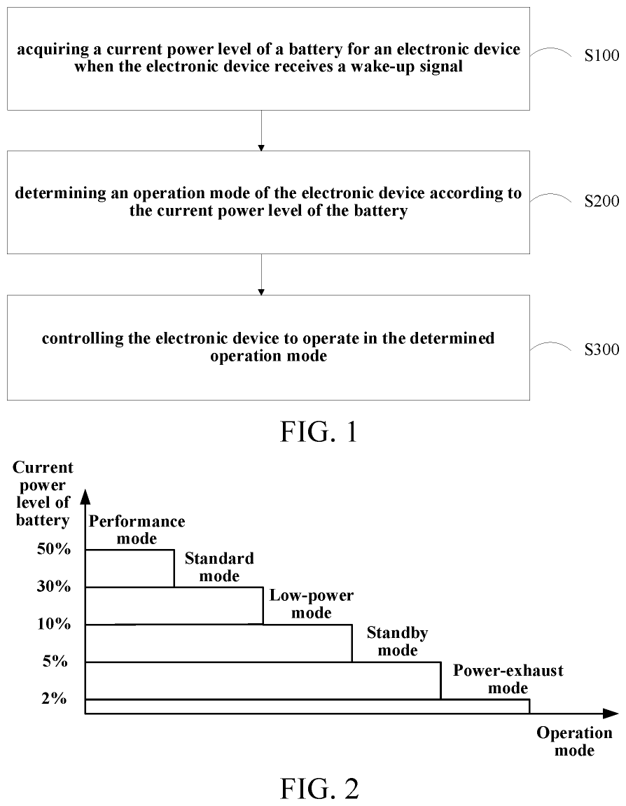

In a specific example shown in FIG. 2, when the current power level of the battery is greater than or equal to 50% of the full power level of the battery, the performance mode is determined as the operation mode of the electronic device; when the current power level of the battery is less than 50% of the full power level of the battery, and is greater than or equal to 30% of the full power level of the battery, the standard mode is determined as the operation mode of the electronic device; when the current power level of the battery is less than 30% of the full power level of the battery, and is greater than or equal to 10% of the full power level of the battery, the low-power mode is determined as the operation mode of the electronic device; when the current power level of the battery is less than 10% of the full power level of the battery, and is greater than or equal to 5% of the full power level of the battery, the standby mode is determined as the operation mode of the electronic device; and when the current power level of the battery is less than 5% of the full power level of the battery, the power-exhaust mode is determined as the operation mode of the electronic device. In addition, when the current power level of the battery is less than 2% of the full power level of the battery, a basic function of the electronic device may not be supported. In this case, the electronic device may be shut down automatically to protect the device and data therein.

It can be understood that in some other specific examples, more or fewer operation modes may be preset for the electronic device, and the corresponding relationship between the current power level of the battery and the operation mode may be established, thereby determining the corresponding operation mode after the electronic device is woken up according to the current power level of the battery, which is not limited herein.

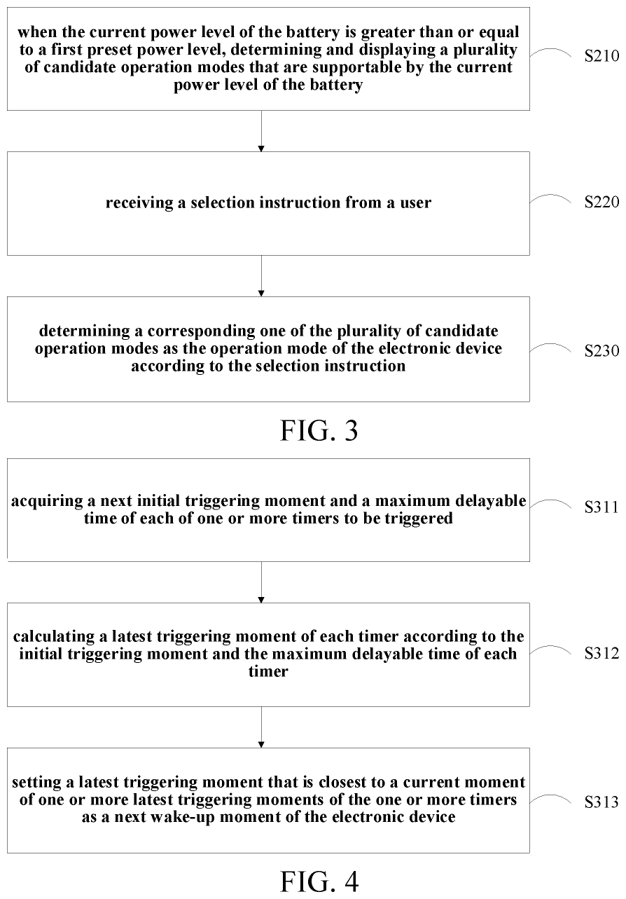

In some other embodiments, in a case that a condition is met, a user can select a desired operation mode from a plurality of candidate operation modes according to an actual demand thereof, thereby improving the flexibility of setting an operation mode in the electronic device, and meeting the demand of the user better. As shown in FIG. 3, in a specific embodiment of the present disclosure, determining the operation mode of the electronic device according to the current power level of the battery may include:

step S210: when the current power level of the battery is greater than or equal to a first preset power level, determining and displaying a plurality of candidate operation modes that are supportable by the current power level of the battery;

step S220: receiving a selection instruction from a user; and

step S230: determining a corresponding one of the plurality of candidate operation modes as the operation mode of the electronic device according to the selection instruction.

Specifically, in a case that the current power level of the battery is relatively high, a plurality of operation modes may be supportable. For some users, if it is convenient for them to charge or replace the battery of the electronic device, the users may hope that the electronic device continues to operate the function with relatively high power consumption. When the battery power level is insufficient to support the function, the users directly charge or replace the battery. However, for some other users, if it is inconvenient for them to charge or replace the battery of the electronic device (for example, in a case that the users are in the wild), the users may hope that the electronic device can operate as long as possible, that is, the battery can have the endurance time as long as possible. To facilitate the user to select the operation mode after the electronic device is woken up according to their actual demand, after a plurality of candidate operation modes that are supportable by the current power level are determined, the plurality of candidate operation modes may be displayed to the user via the user interaction interface (for example, the graphical user interface or the like) of the electronic device, and then, the user may transmit the selection instruction thereof to the electronic device by the user interaction interface (for example, the key, the touch screen or the like), thereby determining a corresponding one of the plurality of candidate operation modes as the operation mode after the electronic device is woken up.

In some embodiments, especially in a case that the current power level of the battery is relatively low, the operation mode after the electronic device is woken up may be directly determined according to the preset corresponding relationship, instead of determining the operation mode based on the selection instruction of the user, so that the battery can last for a longer time in a case that the power level is low. Specifically, determining the operation mode of the electronic device according to the current power level of the battery may further include: when the current power level of the battery is less than a second preset power level, determining an operation mode corresponding to the current power level of the battery as the operation mode of the electronic device.

It can be understood that an implementation in which the user selects the desired operation mode from the candidate operation modes and an implementation in which the operation mode is determined directly according to the battery power level may be combined with each other. For example, in a specific embodiment, the second preset power level may be less than or equal to the first preset power level, then when the current power level of the battery is greater than or equal to the first preset power level, the operation mode meeting the condition may be determined according to the selection instruction of the user; while when the current power level of the battery is less than the second preset power level, the operation mode of the electronic device may be determined directly according to the current power level.

Taking the foregoing electronic device including five operation modes as an example, if the current power level of the battery is greater than or equal to the third preset proportion (for example, 10%) of the full power level of the battery, it can be determined that the candidate operation modes include the performance mode, the standard mode, and the low-power mode. Then, the three candidate operation modes may be displayed to the user, and the selection instruction from the user is received. Further, one of the operation modes may be determined as the operation mode after the electronic device is woken up according to the selection instruction, thereby meeting the specific demand of the user. On the other hand, if the current power level of the battery is less than the third preset proportion of the full power level of the battery, the operation mode corresponding to the current power level of the battery may be directly determined as the operation mode of the electronic device. For example, if the current power level is less than the third preset proportion of the full power level of the battery, and is greater than or equal to the fourth preset proportion (for example, 5%) of the full power level of the battery, the standby mode is determined as the operation mode after the electronic device is woken up; and if the current power level of the battery is less than the fourth preset proportion of the full power level of the battery, the power-exhaust mode is determined as the operation mode after the electronic device is woken up.

It can be understood that in some other specific examples, more or fewer operation modes may be preset for the electronic device, the specific value of the first preset power level or the second preset power level may be changed, and the corresponding relationship between the current power level of the battery and the operation mode may be established, thereby determining the corresponding operation mode after the electronic device is woken up according to at least one of the current power level of the battery or the selection instruction from the user, which is not limited herein.

In some embodiments, the user may further customize a specific function that can be implemented in one or more operation modes. Specifically, the battery management method may further include: receiving a customization instruction from the user when the electronic device is in a wake-up state; and determining a function contained in a corresponding operation mode according to the customization instruction. It should be noted that the maximum power of the function contained in the customized operation mode should be supportable by the remaining power level of the battery corresponding to the operation mode. The customized function or operation mode may be made to meet this requirement by displaying only the function that meets the power condition to the user for selection or checking the maximum power of the function customized by the user. The user may customize the function in at least one operation mode directly by the electronic device or by an application (APP) on a mobile terminal, such as a smart phone, in communication with the electronic device. In a specific example, when the electronic device is a video camera, a functions customized or equipped in each operation mode may have a different parameter and the like. For example, switches of different intelligent algorithms may be set, different algorithm parameters may be set, an adjustment range or a switch of an audio volume may be set, or an adjustment range or a switch of a brightness of a fill light may be set. That is, the user may voluntarily configure a function combination in the operation mode according to needs.

Returning to FIG. 1, in an exemplary embodiment of the present disclosure, the battery management method may further include:

step S300: controlling the electronic device to operate in the determined operation mode.

Because the maximum power in the determined operation mode is supportable by the current power level of the battery, the crash, restart and the like of the electronic device due to the insufficient battery power level may be effectively avoided. Moreover, the electronic device is enabled to operate in a corresponding operation mode according to different current power levels, so that the remaining power level of the battery can be fully used for prolonging the endurance time of the battery. For example, even if the current power level of the battery is less than 5% of the full power level, the remaining power level may be used for enabling the electronic device to support some functions with low power consumption, thereby prolonging the endurance time of the battery as much as possible.

In some embodiments, to enable the electronic device to be in a keep-alive state, the electronic device usually needs to be periodically woken up using a preset timer during the dormant period of the electronic device, and necessary operations, such as starting to process some external inputs, and monitoring and updating system state parameters and the like, are performed in the wake-up period of the electronic device. However, for multiple operations, it usually requires waking up the electronic device at different moments or in different cycles, which causes the electronic device to be woken up frequently or even almost randomly. The more times it is woken up, the greater the power consumption of the electronic device will be, and the shorter endurance time of the battery will be. Especially, in the electronic device such as a video camera or a camera, the dormant time thereof may account for more than 90% of the total endurance time of the battery. If the dormant state is frequently interrupted, the endurance capability is greatly reduced.

To solve the foregoing problem, at least one of a delay attribute or an advance attribute of the timer may be added when the timer in the electronic device is created or set. That is, in addition to setting an initial triggering moment of the timer, at least one of a delay able time or an advanceable time of the timer may also be set in the timer. At least one of the delay able time or the advanceable time may be set according to a corresponding service feature. Usually, at least one of the delayable time or the advanceable time may be conveniently set in a software timer. In this way, a time period that can actually trigger the timer is expanded into a range from an earliest triggering moment to a latest triggering moment, wherein the earliest triggering moment is the initial triggering moment of the timer minus the maximum advanceable time, and the latest triggering moment is the initial triggering moment of the timer plus the maximum delayable time. In general, the timer may be periodically triggered; or its next trigger time may be reset when the timer is triggered. In addition, when the electronic device is in the dormant state, the software timer may not be actively triggered, therefore, a next wake-up moment of the electronic device may be set in a hardware timer. The hardware timer may also be normally triggered when the electronic device is in the dormant state, thereby ensuring the normal operation of the electronic device. In an exemplary embodiment of the present disclosure, when a certain hardware timer is triggered, according to the triggerable time period of each timer (which may include the software timer and the hardware timer) to be triggered, as many timers as possible may be triggered and perform corresponding operations in the same wake-up time period of the electronic device, thereby reducing the number of times of waking up the electronic device, reducing the power consumption, and prolonging the endurance time.

On the one hand, as shown in FIG. 4, controlling the electronic device to operate in the determined operation mode may include:

step S311, acquiring a next initial triggering moment and a maximum delayable time of each of one or more timers to be triggered;

step S312, calculating a latest triggering moment of each timer according to the initial triggering moment and the maximum delayable time of each timer; and

step S313, setting a latest triggering moment that is closest to a current moment of one or more latest triggering moments of the one or more timers as a next wake-up moment of the electronic device.

In this way, when determining the next wake-up moment, the latest triggering moment that is closest to the current moment of one or more latest triggering moments of the one or more timers to be triggered is set as the next wake-up moment of the electronic device, so as to avoid missing triggering of a timer that needs to be triggered, thereby ensuring the normal operation of the necessary function of the electronic device, and effectively reducing the number of times of waking up the electronic device.

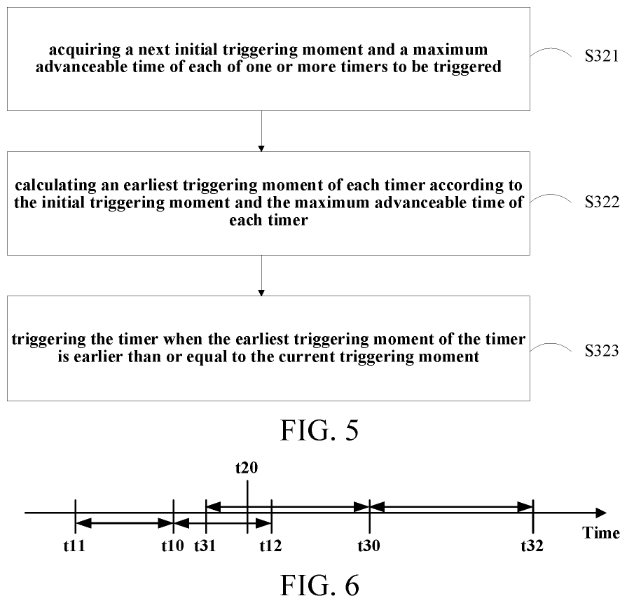

On the other hand, as shown in FIG. 5, controlling the electronic device to operate in the determined operation mode may include:

step S321, acquiring a next initial triggering moment and a maximum advanceable time of each of one or more timers to be triggered;

step S322, calculating an earliest triggering moment of each timer according to the initial triggering moment and the maximum advanceable time of each timer; and

step S323: triggering the timer when the earliest triggering moment of the timer is earlier than or equal to a current triggering moment.

In this way, each time the electronic device is woken up, it is possible to check whether an additional timer meeting the condition, namely a timer whose earliest triggering moment is earlier than or equal to the current triggering moment, can be triggered in the current wake-up time period, and the timer is triggered and a corresponding operation is performed if such a timer exists, thereby avoiding the situation that the electronic device is frequently woken up after restoring to the dormant state, and prolonging the endurance time of the battery.

In a specific example, as shown in FIG. 6, it is assumed that there are three timers to be triggered in total, for the next triggering, the first initial triggering moment of the first timer is t10, and the triggerable time period thereof ranges from t11 to t12 based on the maximum delayable time and the maximum advanceable time; the second initial triggering moment of the second timer is t20, and cannot be delayed or advanced; and the third initial triggering moment of the third timer is t3, and the triggerable time period thereof ranges from t31 to t32 based on the maximum delayable time and the maximum advanceable time. Then, as can be learned from FIG. 6, the latest triggering moment of the first timer is t12, the latest triggering moment of the second timer is t20, and the latest triggering moment of the third timer is t32. It can be seen that t20 which arrives at the earliest can be determined as the next wake-up moment of the electronic device. In addition, if one of the first timer to the third timer is the hardware timer, t20 may be recorded in the hardware timer so as to wake up the electronic device. Otherwise, an additional hardware timer may be set to record t20 so as to wake up the electronic device. On the other hand, as shown in FIG. 6, after the electronic device is woken up at t20, because the earliest triggering moment of the third timer is t31, which is earlier than the current triggering moment t20, in this case, the third timer may be triggered and a corresponding operation may be performed, so as to reduce the number of times of subsequently waking up the electronic device and to prolong the endurance time.

In an exemplary embodiment of the present disclosure, the operation state of the electronic device is determined according to the current power level of the battery when the electronic device is woken up, so that the function that can be implemented by the electronic device can be controlled based on a difference of the remaining power level of the battery. This can not only improve the maximum operation performance of the electronic device, but also promote the sufficient release of the battery power level, thereby contributing to prolonging of the endurance time. Further, in some embodiments, by setting at least one of the delay able time or the advanceable time of the timers, as many timers as possible are triggered and perform the corresponding operations in the same wake-up time period, thereby effectively reducing the number of times of waking up the electronic device, and further prolonging the endurance time of the battery. Compared with the manner of reducing the number of times of wake-up by reducing the system timing precision, in the implementation of the present application, the delay able time and the advanceable time can be freely set according to the service situation, so that batch integration processing of the timers can be implemented while keeping the system timing precision unchanged.

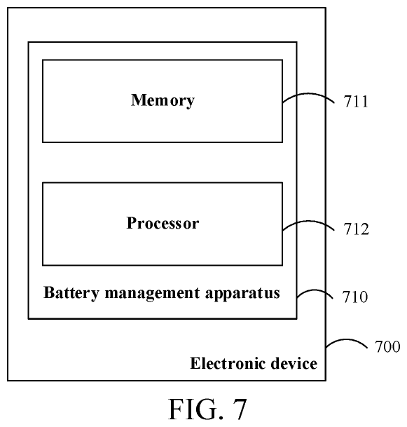

The present disclosure further provides a battery management apparatus 710 for an electronic device 700. As shown in FIG. 7, the battery management apparatus 710 may include a memory 711 and a processor 712. The memory 711 has instructions stored thereon. When the instructions are executed by the processor 712, steps of the foregoing battery management method may be implemented. In the specific example shown in FIG. 7, the battery management apparatus 710 may be integrated into the electronic device 700. However, it can be understood that in some other examples, the battery management apparatus may be arranged independent of the electronic device, and is electrically connected to the electronic device.

The processor 712 may perform various actions and processing according to the instructions stored in the memory 711. Specifically, the processor 712 may be an integrated circuit chip and has a signal processing capability. The foregoing processor may be a general-purpose processor, a digital signal processor (DSP), an application-specific integrated circuit (ASIC), a field programmable gate array (FPGA), or another programmable logic device, discrete gate or transistor logic device, or discrete hardware component. Various methods, steps, and logical block diagrams disclosed in the embodiments of the present disclosure may be implemented or performed. The general-purpose processor may be a microprocessor, or the processor may be any conventional processor, such as an X86 architecture, an ARM architecture or the like.

The memory 711 stores executable instructions, and the instructions are executed by the processor 712 to implement the foregoing battery management method. The memory 711 may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) used as an external cache. By way of exemplary but not restrictive description, many forms of RAM are available, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DR RAM). It should be noted that the memory in the method described herein is intended to include but is not limited to these memories and any other suitable type of memory.

The present disclosure further provides an electronic device. The electronic device may include the battery management apparatus as mentioned above. In some embodiments, the electronic device may include one of a video camera or a camera. It can be understood that in some other embodiments, the electronic device may also be an intelligent terminal of another type, or the like.

The present disclosure further provides a computer-readable storage medium. The computer-readable storage medium has instructions stored thereon. When the instructions are executed by a processor, steps of the battery management method as mentioned above can be implemented.

Similarly, the computer-readable storage medium in the embodiments of the present disclosure may be a volatile memory or a non-volatile memory, or may include both a volatile memory and a non-volatile memory. It should be noted that the computer-readable storage medium described herein is intended to include but is not limited to these memories and any other suitable type of memory.

The present disclosure further provides a computer program product. The computer program product includes instructions. When the instructions are executed by a processor, steps of the battery management method as mentioned above can be implemented.

The instruction may be any instruction set, such as machine codes, to be directly executed by one or more processors, or any instruction set, such as a script, to be indirectly executed. The terms “instruction”, “application”, “process”, “step”, and “program” herein may be used interchangeably herein. The instructions may be stored in a target code format so as to be directly processed by one or more processors, or be stored in any other computer language, including scripts or sets of independent source code modules that are interpreted on demand or compiled in advance. The instructions may include instructions causing, for example, one or more processors to serve as each neural network herein. The functions, methods, and routines of the instructions are explained in more detail in other parts herein.

In all examples that are shown and discussed herein, any specific value should be interpreted only as an example and not as a constraint. Therefore, other examples of the exemplary embodiments may have different values.

The terms “front”, “rear”, “top”, “bottom”, “above”, “below”, and the like in the description and in the claims, if any, are used for descriptive purposes and may not necessarily be used for describing constant relative positions. It should be understood that the terms used in such a way are interchangeable in proper circumstances, so that the embodiments of the present disclosure described herein can, for example, operate in other orientations different from those shown herein or otherwise described.

As used herein, the term “exemplary” means “used as an example, instance, or illustration”, and is not intended to be a “model” to be accurately copied. Any implementation illustratively described herein is not necessarily to be construed as preferred or advantageous over other implementations. Moreover, the present disclosure is not limited by any theory expressed or implied in the foregoing technical field, background, summary or detailed description.

As used herein, the term “substantially” means that any minor variation caused by at least one of the defects of design or manufacture, the tolerance of devices or elements, the environmental influence, or other factors is included. The term “substantially” also allows for differences from perfect or ideal situations due to parasitic effects, noise, and other practical considerations that may exist in practical implementations.

The foregoing descriptions may indicate elements or nodes or features that are “connected” or “coupled” together. As used herein, unless otherwise explicitly specified, “connected” means that one element/node/feature is directly connected to (or directly communicates with) another element/node/feature electrically, mechanically, logically, or in other manners. Similarly, unless otherwise explicitly specified, “coupled” means that one element/node/feature may be directly or indirectly connected to another element/node/feature mechanically, electrically, logically, or in other manners to allow interaction, even though the two features may not be directly connected. That is, “coupled” is intended to include direct and indirect connections between elements or other features, including connections using one or more intermediate elements.

It should also be understood that the term “comprise/include”, when used herein, specifies the presence of indicated features, integers, steps, operations, units, or components, but does not exclude the presence or addition of one or more other features, integers, steps, operations, units, or components, or combinations thereof.

Those skilled in the art should be aware that the boundary between the foregoing operations is merely illustrative. A plurality of operations may be combined into a single operation, a single operation may be distributed in an additional operation, and the operations may be performed at least partially overlapping in time. Moreover, alternative embodiments may include a plurality of examples of particular operations, and the operation sequence may be changed in other various embodiments. However, other modifications, changes, and replacements are also possible. Therefore, the specification and accompanying drawings should be regarded as illustrative rather than restrictive.

Despite some particular embodiments of the present disclosure have been illustrated in detail by the examples, those skilled in the art should understand that the foregoing examples are merely intended to describe rather than to limit the scope of the present disclosure. Each embodiment disclosed herein may be randomly combined without departing from the spirit and scope of the present disclosure. Those skilled in the art should also understand that various modifications may be made to the embodiments without departing from the scope and spirit of the present disclosure. The scope of the present disclosure is defined by the appended claims.

1. A battery management method for an electronic device, comprising:
acquiring a current power level of a battery for the electronic device when the electronic device receives a wake-up signal;
determining an operation mode of the electronic device according to the current power level of the battery, wherein a maximum power in the determined operation mode is supportable by the current power level of the battery; and
controlling the electronic device to operate in the determined operation mode.

2. The battery management method according to claim 1, wherein the wake-up signal comprises at least one of:
a key triggering signal;
a touch screen triggering signal; or
a timer triggering signal.

3. The battery management method according to claim 2, wherein a timer configured to generate the timer triggering signal comprises at least one of a software timer or a hardware timer.

4. The battery management method according to claim 1, wherein determining the operation mode of the electronic device according to the current power level of the battery comprises:
determining a preset operation mode corresponding to the current power level of the battery as the operation mode of the electronic device according to a preset corresponding relationship between the current power level of the battery and the operation mode of the electronic device.

5. The battery management method according to claim 1, wherein determining the operation mode of the electronic device according to the current power level of the battery comprises at least one of:
when the current power level of the battery is greater than or equal to a first preset power level, determining and displaying a plurality of candidate operation modes that are supportable by the current power level of the battery, receiving a selection instruction from a user, and determining a corresponding one of the plurality of candidate operation modes as the operation mode of the electronic device according to the selection instruction; or
when the current power level of the battery is less than a second preset power level, determining an operation mode corresponding to the current power level of the battery as the operation mode of the electronic device,
wherein the second preset power level is less than or equal to the first preset power level.

6. The battery management method according to claim 1, further comprising:
receiving a customization instruction from a user when the electronic device is in a wake-up state; and
determining a function contained in a corresponding operation mode according to the customization instruction.

7. The battery management method according to claim 1, wherein the operation mode of the electronic device comprises at least one of:
a first operation mode, wherein in the first operation mode, the electronic device is capable of implementing all functions;
a second operation mode, wherein in the second operation mode, a function with the maximum power greater than or equal to a first maximum power threshold in the electronic device is disabled;
a third operation mode, wherein in the third operation mode, a peripheral device that is powered by the electronic device and has the maximum power greater than or equal to a second maximum power threshold is disabled;
a fourth operation mode, wherein in the fourth operation mode, local triggering wake-up of the electronic device is disabled, and the electronic device is in a network on-line state; or
a fifth operation mode, wherein in the fifth operation mode, the electronic device is in a network off-line state, and the electronic device remains in local charged dormancy,
wherein a first maximum power in the first operation mode is greater than a second maximum power in the second operation mode, the second maximum power in the second operation mode is greater than a third maximum power in the third operation mode, the third maximum power in the third operation mode is greater than a fourth maximum power in the fourth operation mode, and the fourth maximum power in the fourth operation mode is greater than a fifth maximum power in the fifth operation mode.

8. The battery management method according to claim 7, wherein determining the operation mode of the electronic device according to the current power level of the battery comprises:
when the current power level of the battery is greater than or equal to a first preset proportion of a full power level of the battery, determining the first operation mode as the operation mode of the electronic device;
when the current power level of the battery is less than the first preset proportion of the full power level of the battery, and is greater than or equal to a second preset proportion of the full power level of the battery, determining the second operation mode as the operation mode of the electronic device;
when the current power level of the battery is less than the second preset proportion of the full power level of the battery, and is greater than or equal to a third preset proportion of the full power level of the battery, determining the third operation mode as the operation mode of the electronic device;
when the current power level of the battery is less than the third preset proportion of the full power level of the battery, and is greater than or equal to a fourth preset proportion of the full power level of the battery, determining the fourth operation mode as the operation mode of the electronic device; or
when the current power level of the battery is less than the fourth preset proportion of the full power level of the battery, determining the fifth operation mode as the operation mode of the electronic device,
wherein the first preset proportion is greater than the second preset proportion, the second preset proportion is greater than the third preset proportion, and the third preset proportion is greater than the fourth preset proportion.

9. The battery management method according to claim 8, wherein the first preset proportion is 45%˜50% or 50%˜55%, the second preset proportion is 25%˜30% or 30%˜35%, the third preset proportion is 7%˜10% or 10%˜13%, and the fourth preset proportion is 2%˜5% or 5%˜8%.

10. The battery management method according to claim 1, wherein controlling the electronic device to operate in the determined operation mode comprises:
acquiring a next initial triggering moment and a maximum delayable time of each of one or more timers to be triggered,
calculating a latest triggering moment of each timer according to the initial triggering moment and the maximum delayable time of each timer, and
setting a latest triggering moment that is closest to a current moment of one or more latest triggering moments of the one or more timers as a next wake-up moment of the electronic device.

11. The battery management method according to claim 10, wherein the next wake-up moment of the electronic device is set in a hardware timer.

12. A battery management apparatus for an electronic device, comprising a memory and a processor, wherein the memory has instructions stored thereon, and when the instructions are executed by the processor, steps of the battery management method according to claim 1 are implemented.

13. An electronic device, comprising the battery management apparatus according to claim 12.

14. The electronic device according to claim 13, comprising at least one of a video camera or a camera.

15. A computer-readable storage medium, wherein the computer-readable storage medium has instructions stored thereon, and when the instructions are executed by a processor, steps of the battery management method according to claim 1 are implemented.

16. (canceled)

17. The battery management method according to claim 1, wherein
controlling the electronic device to operate in the determined operation mode comprises:
acquiring a next initial triggering moment and a maximum advanceable time of each of one or more timers to be triggered,
calculating an earliest triggering moment of each timer according to the initial triggering moment and the maximum advanceable time of each timer, and
triggering the timer when the earliest triggering moment of the timer is earlier than or equal to a current triggering moment.

18. The battery management method according to claim 17, wherein
at least one of the delayable time or the advanceable time of the timer is set when the timer is created.
